(19) United States
(12) Patent Application Publication
(10) Pub. No.: US 2026/0246735 A1
(43) Pub. Date: Aug. 20, 2026

(54) SYSTEM AND METHOD FOR GLOBAL SLICE AND/OR DNN REGISTRY

(71) Applicant: Boost SubscriberCo L.L.C., Englewood, CO (US)

(72) Inventor: Dale Drew, Arvada, CO (US)

(21) Appl. No.: 19/056,540

(22) Filed: Feb. 18, 2025

(51) Int. Cl. H04L 45/64

(52) U.S. Cl. CPC H04L 45/64

(57) ABSTRACT

A method for providing equivalent services to user devices across multiple participating telecommunication networks is disclosed. The method includes: accessing a global network slice registry for user devices, wherein each slice is used to identify and route traffic to a specific network service; registering slice ranges that can be accessed by other participating telecommunication networks of the multiple participating telecommunication networks; creating unified slice IDs with associated slice ranges for each corresponding user device that can be accessed by the multiple participating telecommunication networks; using the unified slice IDs to enable routing to equivalent slice functionality for the network service in each of the multiple participating telecommunication networks; and creating a slice overlay network that provides user devices with an equivalent network service in the multiple participating telecommunication networks.

### BACKGROUND

Data between User Equipment and a network may travel through various components along the data path in a cellular network. In most cases, the resource allocation and the data path is configured statically or semi-statically. A specific set of parameters assigned for the User Equipment is called a network slice. A network slice is a logical end-to-end network that is created dynamically, and which is optimized for a specific User Equipment or use cases. A user equipment (UE) can access multiple slices over one access network, such as over the same radio interface.

For example, in a 5G network there are network slices that are associated with various functions, such security functions. When a customer connects into its own network, slice orchestration may be used to route the customer to the appropriate network slice using network slice IDs. In this manner, the customer receives native access to the appropriate features and functions inside its own network.

While this technique works well within a customer's home network, there is currently no analogous solution for when customers roam on other networks outside of their home network. It is with respect to these and other considerations that the embodiments described herein have been made.

### BRIEF SUMMARY

The present disclosure relates generally to telecommunication networks, more particularly, to the system and method of for a global slice registry. Briefly stated, one or more methods providing equivalent services to user devices across multiple participating telecommunication networks are disclosed. Some such methods include: accessing a global slice registry for user devices, wherein each slice is used to identify and route traffic to a specific network service; registering slice ranges that can be accessed by other participating telecommunication networks of the multiple participating telecommunication networks; creating unified slice IDs with associated slice ranges for each corresponding user device that can be accessed by the multiple participating telecommunication networks; using the unified slice IDs to enable routing to equivalent slice functionality for the network service in each of the multiple participating telecommunication networks; and creating a slice overlay network that provides user devices with an equivalent network service the in multiple participating telecommunication networks.

In one or more embodiments of the method for providing equivalent services to user devices across multiple participating telecommunication networks, the method further comprises: routing information between network carriers in the multiple participating telecommunication networks using slice ID routing without using public internet. In another aspect of some embodiments, a managed security solution infrastructure is hosted at a host network in the multiple participating telecommunication networks, and the host network enables participation by users of a remainder of the multiple participating telecommunication networks by presenting the unified slice ID that is stored in the global slice registry. In still another aspect of some embodiments, the specific network service is one or more of a security service, a low latency service, a high availability service, a data analytics service, a threat detection service, and an autonomous vehicle telemetry service. In yet another aspect of some embodiments, the method further comprises: routing a network customer that is roaming in a roaming network, which is part of the multiple participating telecommunication networks, to a slice range in a home network of the network customer using its associated slice ID.

In some embodiments of the global slice registry method, the method further comprises: in response to receiving a slice ID from a network customer that is roaming, via a roaming network, sending orchestration data to the roaming network from a home network that enables the roaming network to instantiate a network slice of the home network for the network customer that is roaming. In another embodiment, the global slice registry enables a regional participating telecommunication network of the multiple participating telecommunication networks to provide the same services as provided by a user device of an international participating telecommunication networks of the multiple participating telecommunication networks.

In other embodiments, a system for providing equivalent services to user devices across multiple participating telecommunication networks is disclosed. The system includes a memory that stores computer-executable instructions and a processor that executes the computer-executable instructions that cause the system to: access a global slice and Data Network Name (DNN) registry for user devices, wherein each slice/DNN is used to identify and route traffic to a specific network service; register slice/DNN ranges that can be accessed by other participating telecommunication networks of the multiple participating telecommunication networks; create unified slice/DNN IDs with associated slice/DNN ranges for each corresponding user device that can be accessed by the multiple participating telecommunication networks; use the unified slice/DNN IDs to enable routing to equivalent slice/DNN functionality for the network service in each of the multiple participating telecommunication networks; and create a slice/DNN overlay network that provides user devices with an equivalent network service in the multiple participating telecommunication networks.

In one or more embodiments of the system for equivalent services to user devices across multiple participating telecommunication networks, the memory stores further computer-executable instructions that when executed, cause the system to: route information between network carriers in the multiple participating telecommunication networks using slice ID routing without using public internet. In another aspect of some embodiments, a managed security solution infrastructure is hosted at a host network in the multiple participating telecommunication networks, and wherein the host network enables participation by users of a remainder of the multiple participating telecommunication networks by presenting the unified slice/DNN ID that is stored in the global slice/DNN registry. In still another aspect of some embodiments, the memory stores further computer-executable instructions that when executed, cause the system to: route a network customer that is roaming in a roaming network, which is part of the multiple participating telecommunication networks, to a slice/DNN range in a home network of the network customer using its associated slice/DNN ID.

In some embodiments of the global slice registry system, the memory stores further computer-executable instructions that when executed, cause the system to: in response to receiving a slice/DNN ID from a network customer that is roaming, via a roaming network, send orchestration data to the roaming network from a home network that enables the roaming network to instantiate a network slice of the home network for the network customer that is roaming. In another aspect of some embodiments, the specific network service is one or more of a security service, a low latency service, a high availability service, a data analytics service, a threat detection service, and an autonomous vehicle telemetry service. In still another aspect of some embodiments, the global slice/DNN slice registry enables a regional participating telecommunication network of the multiple participating telecommunication networks to provide the same services as provided by a user device of an international participating telecommunication networks of the multiple participating telecommunication networks.

In still other embodiments, a system for providing equivalent services to user devices across multiple participating telecommunication networks is disclosed. The system includes a memory that stores computer-executable instructions and a processor that executes the computer-executable instructions that cause the system to: register slice ranges that can be accessed by other participating telecommunication networks of the multiple participating telecommunication networks on a global slice registry for user devices, wherein each slice is used to identify and route traffic to a specific network service; create unified slice IDs with associated slice ranges for each corresponding user device that can be accessed by the multiple participating telecommunication networks; and use the unified slice IDs to enable routing to equivalent slice functionality for the network service in each of the multiple participating telecommunication networks.

In one or more embodiments of the system for equivalent services to user devices across multiple participating telecommunication networks, the memory stores further computer-executable instructions that when executed, cause the system to: route information between network carriers in the multiple participating telecommunication networks using slice ID routing without using public internet. In another aspect of some embodiments, a managed security solution infrastructure is hosted at a host network in the multiple participating telecommunication networks, wherein the host network enables participation by users of a remainder of the multiple participating telecommunication networks by presenting the unified slice ID that is stored in the global slice registry. In still another aspect of some embodiments, the memory stores further computer-executable instructions that when executed, cause the system to: route a network customer that is roaming in a roaming network, which is part of the multiple participating telecommunication networks, to a slice range in a home network of the network customer using its associated slice ID.

In some embodiments of the global slice registry system, the memory stores further computer-executable instructions that when executed, cause the system to: in response to receiving a slice ID from a network customer that is roaming, via a roaming network, send orchestration data to the roaming network from a home network that enables the roaming network to instantiate a network slice of the home network for the network customer that is roaming. In another aspect of some embodiments, the specific network service is one or more of a security service, a low latency service, a high availability service, a data analytics service, a threat detection service, and an autonomous vehicle telemetry service. In still another aspect of some embodiments, the global slice registry enables a regional participating telecommunication network of the multiple participating telecommunication networks to provide the same services as provided by a user device of an international participating telecommunication networks of the multiple participating telecommunication networks.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the disclosed invention, reference will be made to the following Detailed Description, which is to be read in association with the accompanying drawings.

FIG. 1 illustrates a context diagram of an environment in which a system for a global DNN and slice registry may be implemented in accordance with embodiments described herein.

FIG. 2 illustrates a diagram of an example system architecture overview of a system in which the environment of FIG. 1 may be implemented in accordance with embodiments described herein.

FIG. 3 illustrates a diagram showing connectivity between certain telecommunication network components during cellular telecommunication.

FIG. 4 illustrates a communication flow within a system for a global slice registry.

FIG. 5 is a logic diagram showing a method for global DNN and slice registry.

FIG. 6 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments of a network slice global registry system. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Advanced cellular networks provide a broad range of wireless services delivered to the end user across multiple access platforms and multi-layer networks. For example, 5G is a dynamic, coherent and flexible framework of multiple advanced technologies supporting a variety of applications. 5G utilizes an intelligent architecture, with Radio Access Networks (RANs) not constrained by base station proximity or complex infrastructure. 5G enables a disaggregated, flexible, and virtual RAN with interfaces creating additional data access points. 5G network functions may be completely software-based and designed as cloud-native, meaning that they are agnostic to the underlying cloud infrastructure, allowing higher deployment agility and flexibility. With the advent of 5G, industry experts defined how the 5G Core (5GC) network should evolve to support the needs of 5G New Radio (NR) and the advanced use cases enabled by it. The 3rd Generation Partnership Project (3GPP) develops protocols and standards for telecommunication technologies including RAN, core transport networks and service capabilities. 3GPP has provided complete system specifications for 5G network architecture which is much more service oriented than previous generations. Future network architectures, such as 6G and others, are expected to utilize many of these features and functionalities.

Multi-Access Edge Computing (MEC) is an important element of 5G architecture. MEC is an evolution in telecommunications that brings the applications from centralized data centers to the network edge, and therefore closer to the end users and their devices. This essentially creates a shortcut in content delivery between the user and host, and the long network path that once separated them. This MEC technology is not exclusive to 5G but is certainly important to its efficiency. Characteristics of the MEC include the low latency, high bandwidth and real time access to RAN information that distinguishes 5G architecture from its predecessors. This convergence of the RAN and core networks enables operators to leverage new approaches to network testing and validation. 5G networks based on the 3GPP 5G specifications provide an environment for MEC deployment. The 5G specifications define the enablers for edge computing, allowing MEC and 5G to collaboratively route traffic. In addition to the latency and bandwidth benefits of the MEC architecture, the distribution of computing power better enables the high volume of connected devices inherent to 5G deployment and the rise of IoT.

The 3rd Generation Partnership Project (3GPP) develops protocols for mobile telecommunications and has developed a standard for 5G. The 5G architecture is based on what is called a Service-Based Architecture (SBA), which leverages IT development principles and a cloud-native design approach. In this architecture, each network function (NF) offers one or more services to other NFs via Application Programming Interfaces (API). Network function virtualization (NFV) decouples software from hardware by replacing various network functions such as firewalls, load balancers and routers with virtualized instances running as software. This eliminates the need to invest in many expensive hardware elements and can also accelerate installation times, thereby providing revenue generating services to the customer faster.

NFV enables the 5G infrastructure by virtualizing appliances within the 5G network. This includes the network slicing technology that enables multiple virtual networks to run simultaneously. NFV may address other 5G challenges through virtualized computing, storage, and network resources that are customized based on the applications and customer segments. The concept of NFV extends to the RAN through, for example, network disaggregation promoted by alliances such as O-RAN. This enables flexibility, provides open interfaces and open-source development, ultimately to ease the deployment of new features and technology with scale. The O-RAN ALLIANCE objective is to allow multi-vendor deployment with off-the-shelf hardware for the purposes of easier and faster inter-operability. Network disaggregation also allows components of the network to be virtualized, providing a means to scale and improve user experience as capacity grows. The benefits of virtualizing components of the RAN provide a means to be more cost effective from a hardware and software viewpoint especially for IoT applications where the number of devices is in the millions.

The 5G New Radio (5G NR) RAN comprises a set of radio base stations (each known as Next Generation Node B (gNB)) connected to the 5G Core (5GC) and to each other. The gNB incorporates three main functional modules: the Centralized Unit (CU), the distributed Unit (DU), and the Radio Unit (RU), which can be deployed in multiple combinations. The primary interface is referred to as the F1 interface between DU and CU and is interoperable across vendors. The CU may be further disaggregated into the CU user plane (CU-UP) and CU control plane (CU-CP), both of which connect to the DU over F1-U and F1-C interfaces, respectively. This 5G RAN architecture is described in 3GPP TS 38.401 V 16.8.0 (2021-12). Each network function (NF) is formed by a combination of small pieces of software code called microservices. Future network architectures, such as 6G and others, are expected to utilize many of these technological improvements, plus additional advancements.

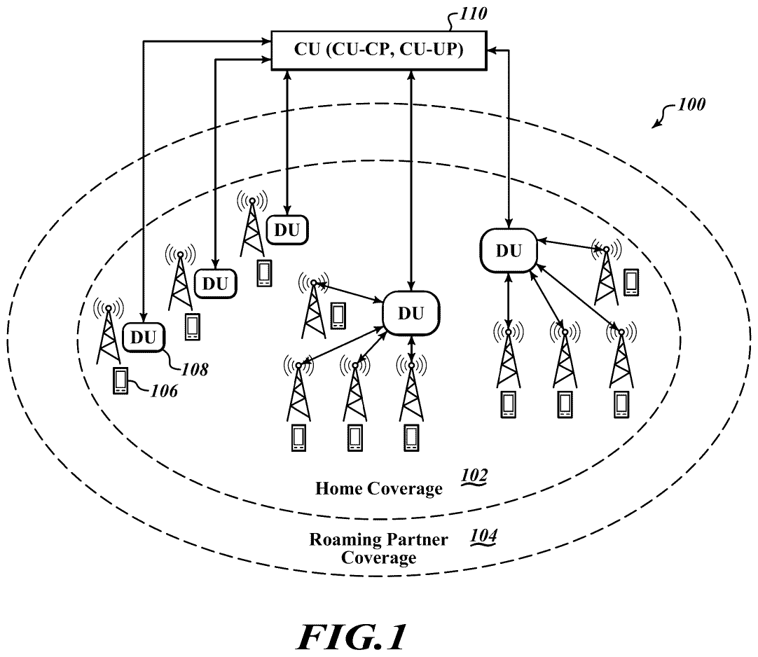

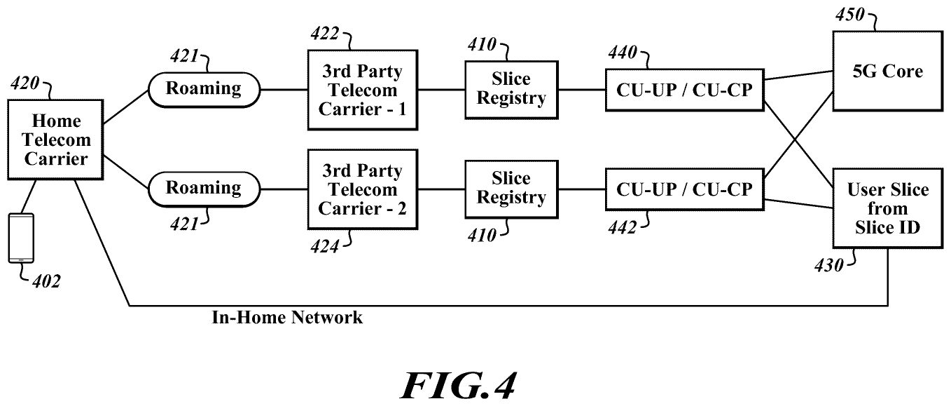

FIGS. 1 and 4 illustrate a context diagram of an environment in which a Network Slice Global Registry System may be implemented in accordance with embodiments described herein. As shown in FIG. 1, a given area 100 will mostly be covered by two or more mobile network operators'wireless networks. Generally, mobile network operators have some roaming agreements that allow users to roam from a home network to a partner network under certain conditions, shown in FIG. 1 as home coverage area 102 and roaming partner coverage area 104. In another embodiment, FIG. 4 shows home telecom network 420 with an agreement that enables its customers 402 to roam 421 under certain conditions in partner telecom networks, namely 3^{rd} Party Telecom Carrier 1—422, and 3^{rd} Party Telecom Carrier 2—424. Referring again to FIG. 1, operators may configure the mobile user's device, referred to herein as user equipment (UE), such as UE 106, with priority and a designated roaming partner network that is used in the roaming partner network coverage area 104. If a UE (e.g., UE 106) cannot find the home network coverage area 102, the UE will be transferred to a partner roaming network in the roaming partner coverage area 104. Thus, service coverage is maintained even if the home coverage area 102 is providing unsatisfactory service coverage.

As shown in FIG. 1, a 5G RAN is split into DUs (e.g., DU 108) that manage scheduling of all the users and a CU (CU-CP, CU-UP) 110 that manages the mobility and radio resource control (RRC) state for all the UEs. The RRC is a layer within the 5G NR protocol stack. It exists only in the control plane, in the UE and in the gNB. The behavior and functions of RRC are governed by the current state of RRC. In 5G NR, RRC has three distinct states: RRC_IDLE, RRC_CONNECTED and RRC_INACTIVE.

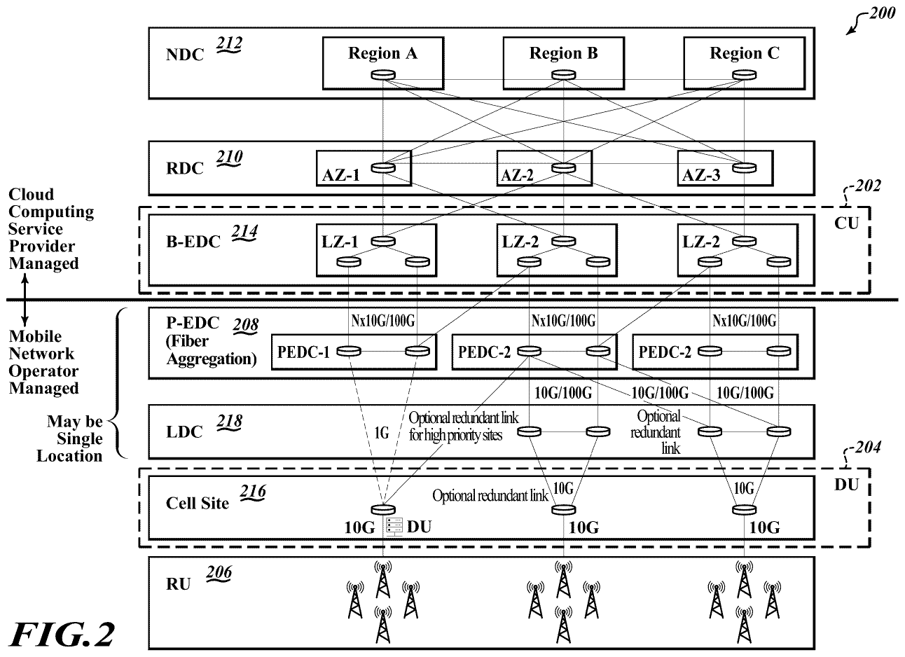

FIG. 2 illustrates a diagram of an example system architecture overview of a system 200 in which the environment of FIG. 1 may be implemented in accordance with embodiments described herein. As shown in FIG. 2, the radio unit (RU) 206 converts radio signals sent to and from the antenna into a digital signal for transmission over packet networks. It handles the digital front end (DFE) and the lower physical (PHY) layer, as well as the digital beamforming functionality.

The DU 204 may sit close to the RU 206 and runs the radio link control (RLC), the Medium Access Control (MAC) sublayer of the 5G NR protocol stack, and parts of the PHY layer. The MAC sublayer interfaces to the RLC sublayer from above and to the PHY layer from below. The MAC sublayer maps information between logical and transport channels. Logical channels are about the type of information carried whereas transport channels are about how such information is carried. This logical node includes a subset of the gNB functions, depending on the functional split option, and its operation is controlled by the CU 202.

The CU 202 is the centralized unit that runs the RRC and Packet Data Convergence Protocol (PDCP) layers. A gNB may comprise a CU and one DU connected to the CU via Fs-C and Fs-U interfaces for control plane (CP) and user plane (UP), respectively. A CU with multiple DUs will support multiple gNBs. The split architecture enables a 5G network to utilize different distribution of protocol stacks between CU 202 and DU 204 depending on mid-haul availability and network design. The CU 202 is a logical node that includes the gNB functions like transfer of user data, mobility control, RAN sharing, positioning, session management, etc., with the exception of functions that may be allocated exclusively to the DU 204. The CU 202 controls the operation of several DUs 204 over the mid-haul interface.

As mentioned above, 5G network functionality is split into two functional units: the DU 204 responsible for real time 5G layer 1 (L1) and 5G layer 2 (L2) scheduling functions, and the CU 202 responsible for non-real time, higher L2 and 5G layer 3 (L3). As shown in FIG. 2, the DU's server and relevant software may be hosted on a cell site 216 itself or can be hosted in an edge cloud (local data center (LDC) 218 or central office) depending on transport availability and fronthaul interface. The CU's server and relevant software may be hosted in a regional cloud data center or as shown in FIG. 2, in a breakout edge data center (B-EDC) 214. As shown in FIG. 2, the DU 204 may be provisioned to communicate via a pass-through edge data center (P-EDC) 208. The P-EDC 208 may provide a direct circuit fiber connection from the DU directly to the primary cloud availability zone (e.g., B-EDC 214) hosting the CU 202. In some embodiments, the LDC 218 and P-EDC 208 may be co-located or in a single location. The CU 202 may be connected to a regional cloud data center (RDC) 210, which in turn may be connected to a national cloud data center (NDC) 212. In the example embodiment, the P-EDC 208, the LDC 218, the cell site 216 and the RU 206 may all be managed by the mobile network operator, and the B-EDC 214, the RDC 210 and the NDC 212 may all be managed by a cloud computing service provider. According to various embodiments, the actual split between DU and RU may be different depending on the specific use-case and implementation.

A virtual private cloud is a configurable pool of shared resources allocated within a public cloud environment. The VPC provides isolation between one VPC user and all other users of the same cloud, for example, by allocation of a private IP subnet and a virtual communication construct (e.g., a VLAN or a set of encrypted communication channels) per user. In some embodiments, this 5G network leverages the distributed nature of 5G cloud-native network functions and cloud flexibility, which optimizes the placement of 5G network functions for optimal performance based on latency, throughput and processing requirements.

In some embodiments, the network architecture utilizes a logical hierarchical architecture consisting of National Data Centers (NDCs), Regional Data Centers (RDCs) and Breakout Edge Data Centers (BEDCs), to accommodate the distributed nature of 5G functions and the varying requirements for service layer integration. In one or more embodiments, BEDCs are deployed in Local Zones hosting 5G NFs that have strict latency budgets. They may also be connected with Pass-through Edge Data Centers (PEDC), which serve as an aggregation point for all Local Data Centers (LDCs) and cell sites in a particular market. BEDCs also provide Internet peering for 5G data service.

In one or more embodiments, an O-RAN network may be implemented that includes an RU (Radio Unit), which is deployed on towers and a DU (Distributed Unit), which controls the RU. These units interface with the Centralized Unit (CU), which is hosted in the BEDC at the Local Zone. These combined pieces provide a full RAN solution that handles all radio level control and subscriber data traffic. In some embodiments, the User Plane Function (Data Network Name (DNN)) is collocated in the BEDC, which anchors user data sessions and routes to the Internet. In another aspect, the BEDCs leverage local Internet access available in Local Zones, which allows for a better user experience while optimizing network traffic utilization.

In one or more embodiments, the Regional Data Centers (RDCs) are hosted in the Region across multiple availability zones. The RDCs host 5G subscribers'signaling processes such as authentication and session management as well as voice for 5G subscribers. These workloads can operate with relatively high latencies, which allows for a centralized deployment throughout a region, resulting in cost efficiency and resiliency. For high availability, multiple RDCs are deployed in a region, each in a separate Availability Zone (AZ) to ensure application resiliency and high availability.

In another aspect of some embodiments, an AZ is one or more discrete data centers with redundant power, networking, and connectivity in a Region. In some embodiments, AZs in a Region are interconnected with high-bandwidth and low-latency networking over a fully redundant, dedicated metro fiber, which provides high-throughput, low-latency networking between AZs. Cloud Native Functions (CNFs) deployed in the RDC utilize a high speed backbone to failover between AZs for application resiliency. CNFs like AMF and SMF, which are deployed in RDC, continue to be accessible from the BEDC in the Local Zone in case of an AZ failure. They serve as the backup CNF in the neighboring AZ and would take over and service the requests from the BEDC.

In this embodiment of the Network Slice Global Registry System, dedicated VPCs are implemented for each Data Center type (e.g., local data center, breakout edge data center, regional data center, national data center, and the like). In some such embodiments, the national data center VPC stretches across multiple Availability Zones (AZs). In another aspect of some embodiments, two or more AZs are implemented per region of the cloud computing service provider. Some embodiments of the 5G Core network functions require support for advanced routing capabilities inside VPC and across VPCs (e.g., UPF, SMF and ePDG). These functions rely on routing protocols such as BGP for route exchange and fast failover (both stateful and stateless). To support these requirements, virtual routers are deployed on EC2 to provide connectivity within and across VPCs, as well as back to the on-prem network.

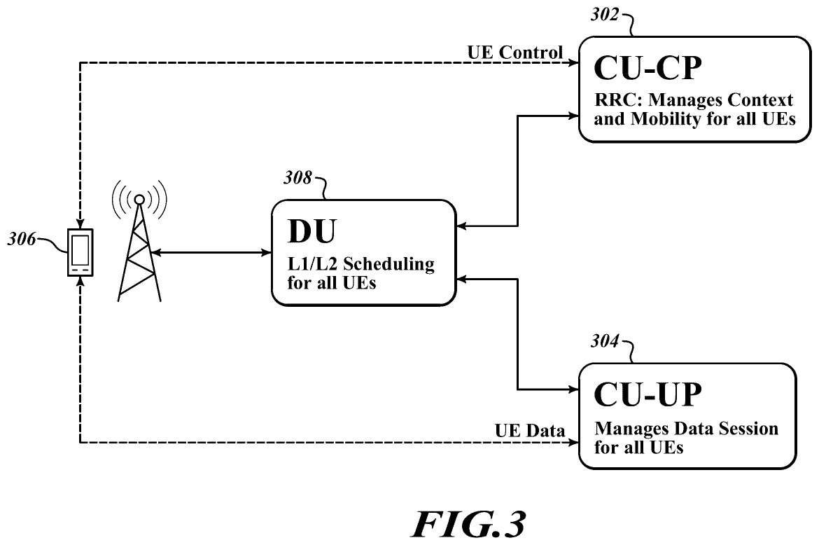

FIG. 3 is a diagram showing connectivity between certain telecommunication network components (e.g., CU 202 and DU 204 of FIG. 2) during cellular telecommunication in accordance with embodiments described herein. Referring still to FIG. 3, the central unit control plane (CU-CP) 302, (e.g., CU 202 of FIG. 2), primarily manages control processing of DUs, such as DU 308 (e.g., DU 204 of FIG. 2), and UEs, such as UE 306. The CU-CP 302 hosts RRC and the control-plane part of the PDCP protocol. CU-CP 302 manages the mobility and radio resource control (RRC) state for all the UEs. The RRC is a layer within the 5G NR protocol stack and manages context and mobility for all UEs. The behavior and functions of RRC are governed by the current state of RRC. In 5G NR, RRC has three distinct states: RRC_IDLE, RRC_CONNECTED and RRC_INACTIVE. The CU-CP 302 terminates the E1 interface connected with the central unit user plane (CU-UP) 304 and the F1-C interface connected with the DU 308. The DU 308 maintains a constant heartbeat with CU 302. The CU-UP 304 manages the data sessions for all UEs 306 and hosts the user plane part of the PDCP protocol. The CU-UP 304 terminates the E1 interface connected with the CU-CP and the F1-U interface connected with the DU 308.

### Network Slice Global Registry System

In some embodiments, the Network Slice Global Registry System provides equivalent services to user devices across multiple participating telecommunication networks by implementing a global network slice registry. Network slicing is a network architecture that enables the multiplexing of virtualized and logical networks on the same physical network infrastructure. Each network slice is an isolated end-to-end network that is designed to provide specific requirements that are needed by a particular user or application.

In slice identity management, individual network slices may be formed by an identifier called Single-Network Slice Selection Assistance Information (S-NSSAI). This slice identifier (ID) is required to achieve end-to-end network slicing. The identifier enables a customer to carry S-NSSAI on User Equipment, RAN, and the Core Network to identify a specific network slice. In some embodiments, there are different slice service types (SST: Slice and Service Type) for different network slices. These slice service types include, by way of example only, and not by way of limitation: eMBB (high speed/large capacity), mIoT (multi-connection, power saving, low cost), and URLLC (low latency, high reliability). The individual network slices identifier is used to identify a network slice across a 5G Core, a 5G-RAN, and the User Equipment.

Referring to FIG. 4, an embodiment of a Network Slice Global Registry System is shown. In some embodiments of the Network Slice Global Registry system, a network slice registry 410 is generated for route IDs to network slices across 5G telecom carriers, such as home telecom carrier 420, 3^{rd} Party Telecom Carrier 1—422, and 3^{rd} Party Telecom Carrier 2—424. In other embodiments of the Network Slice Global Registry system, a network DNN registry is generated for route IDs to Data Network Names (DNNs) across 4G carriers.

In some embodiments of the Network Slice Global Registry system, the route ID information is advertised on a network slice registry 410 that is physically located in an independent third party carrier registry. Alternatively, in another embodiment, the network slice registry 410 is located in one or more of the telecommunication carriers'networks. The network slice registry 410 is then made accessible to the other telecommunication carriers that are participating in a global route registry program for multiple telecommunication networks. For example, in one embodiment of the Network Slice Global Registry system, the home carrier ID range is 1000-5000, the first 3^{rd} Party Carrier ID range is 6000-11000, and the second 3^{rd} Party Carrier ID range is 12000-17000.

In one embodiment of a Network Slice Global Registry method, an operation includes accessing a network slice registry 410 for user devices. Each network slice is used to identify and route traffic for a customer (e.g., User Equipment) 402 to a specific network service. Another operation of this method includes registering network slice ranges in the global network slice registry 410. The registered network slice ranges can then be accessed by other participating telecommunication networks (e.g., 3^{rd} Party Telecom Carrier 1—422, and 3^{rd} Party Telecom Carrier 2—424). Next, an operation of the Network Slice Global Registry method includes creating network slice IDs with associated slice ranges (e.g., user slice 430) for a corresponding customer 402 that can be accessed by the multiple participating telecommunication networks (e.g., 3^{rd} Party Telecom Carrier 1—422, and 3^{rd} Party Telecom Carrier 2—424). The Network Slice Global Registry method uses the network slice IDs to enable routing to the user slice 430 and equivalent slice functionality for the network service in each of the multiple participating telecommunication networks. In this manner, the Network Slice Global Registry method creates a slice overlay network that provides customer 402 with the equivalent network service (SST: Slice and Service Type) in each of the multiple participating telecommunication networks (e.g., 3^{rd} Party Telecom Carrier 1—422, and 3^{rd} Party Telecom Carrier 2—424).

Additionally, in some embodiments of the Network Slice Global Registry system, information connecting a customer 402 to its home network user slice 430 (and associated parameters) is routed using network slice IDs between telecom carriers in the multiple participating telecommunication networks without using public internet. For example, in one embodiment, a managed security solution infrastructure is hosted at a host network in the multiple participating telecommunication networks (e.g., 3^{rd} Party Telecom Carrier 1—422, and 3^{rd} Party Telecom Carrier 2—424). In such an embodiment, the home telecom carrier 420 enables the multiple participating telecommunication networks to access the network slices IDs (routing ranges) in the network slice registry 410. In some embodiments, the specific network service that is accessed by the roaming customer 402 using the network slice 430 includes one or more of a security service, a low latency service, a high availability service, a data analytics service, a threat detection service, and an autonomous vehicle telemetry service.

Specifically, in one embodiment, the customer 402 from a home telecom network 420 is connected to and roaming 421 in a third party telecommunications network (e.g., 3^{rd} Party Telecom Carrier 1—422, or 3^{rd} Party Telecom Carrier 2—424), which is part of the multiple participating telecommunication networks. The roaming customer in the 3^{rd} Party Telecom Carrier 1—422, or 3^{rd} Party Telecom Carrier 2—424 may also connect through the CU user plane (CU-UP) and CU control plane (CU-CP) 440, 442, respectively. The roaming customer 402 is then routed to a user slice 430 in the roaming customer's home network 420 via its associated slice ID. The roaming customer in the 3^{rd} Party Telecom Carrier 1—422, or 3^{rd} Party Telecom Carrier 2—424 may also connect through the CU user plane (CU-UP) and CU control plane (CU-CP) 440, 442 to the 5G Core 450. In some embodiments, the network slice registry 410 enables a regional participating telecommunication network to provide the same services as those provided by an international participating telecommunication networks that is part of the multiple participating telecommunication networks.

In other embodiments, the Network Slice Global Registry system is configured to receive a slice ID (associated with a network customer 402 (e.g., User Equipment) that is roaming 421) from a third party telecommunications network (e.g., 3^{rd} Party Telecom Carrier 1—422, or 3^{rd} Party Telecom Carrier 2—424) in which the network customer 402 is roaming 421. In response, the Network Slice Global Registry system sends orchestration data to the third party telecommunications network (e.g., 3^{rd} Party Telecom Carrier 1—422, or 3^{rd} Party Telecom Carrier 2—424) in which the network customer 402 is roaming 421. This orchestration data enables the telecommunications network (e.g., 3^{rd} Party Telecom Carrier 1—422, or 3^{rd} Party Telecom Carrier 2—424) in which the network customer 420 is roaming 421 to instantiate the network slice 430 (and associated features and functions) of the home telecommunications network 420 for the network customer 402 that is roaming 421. In this manner, the home telecommunications network 420 offers ubiquitous services to their network customers 402, so that they have their same features and functionality (e.g., security, low latency, data analytical, etc.) when they are roaming 421. Otherwise stated, the network customers 402 have access to the specific features and functions of their home network slice 430 when they are roaming 421.

In some embodiments of the Network Slice Global Registry system, security data centers are stored in network slices. These security data centers include security functions such as firewall services, threat detection services, and zero trust services. By using the Network Slice Global Registry system, network customers 402 are routed to their home network slice 430 and associated services, no matter where that customer 402 is roaming 421 out of network, without the customer 402 having to interact the Internet, which could result in many unnecessary security concerns. In another embodiment of the Network Slice Global Registry system involving autonomous vehicle management, the autonomous vehicle is able to travel our wide geographical areas, and no matter where the autonomous vehicle travels, the autonomous vehicle is ensured to have its vehicle information (e.g., telemetry information, etc.) routed back via a secure connection to its home data center using the network slice routing table.

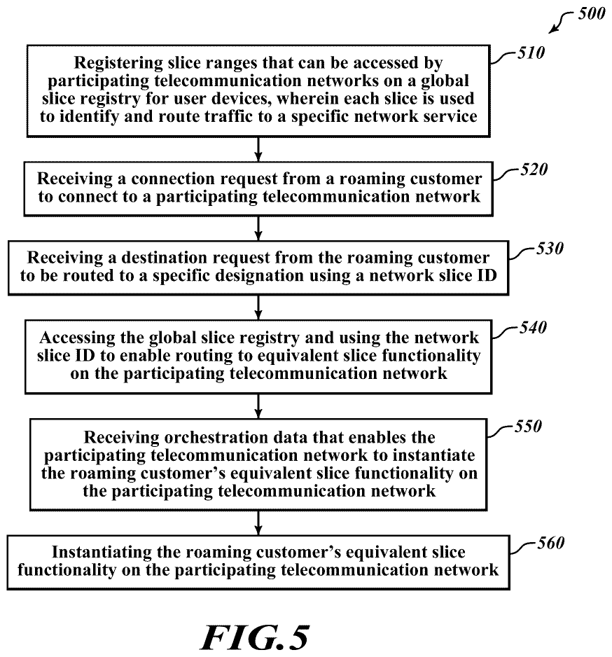

FIG. 5 is a logic diagram showing a method 500 for providing equivalent services to user devices across multiple participating telecommunication networks. This schedule method may be implemented as a 5G architecture, such as shown in FIGS. 1-3 as described above. As shown in FIG. 5, at operation 510, the method includes registering slice ranges that can be accessed by participating telecommunication networks on a global slice registry for user devices, wherein each slice is used to identify and route traffic to a specific network service. At operation 520, the method includes receiving a connection request from a roaming customer to connect to a participating telecommunication network. At operation 530, the method includes receiving a destination request from the roaming customer to be routed to a specific designation using a network slice ID. At operation 540, the method includes accessing the global slice registry and using the network slice ID to enable routing to equivalent slice functionality on the participating telecommunication network. At operation 550, the method includes receiving orchestration data that enables the participating telecommunication network to instantiate the roaming customer's equivalent slice functionality on the participating telecommunication network. At operation 560, the method includes instantiating the roaming customer's equivalent slice functionality on the participating telecommunication network.

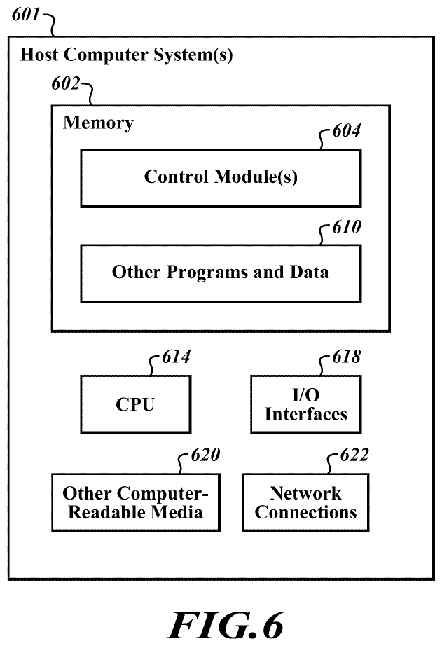

FIG. 6 shows a system diagram that describes an example implementation of a computing system(s) for implementing embodiments described herein. The functionality described herein for a system and method for providing equivalent services to user devices across multiple participating telecommunication networks can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. This proactive scheduling system may be implemented as a 5G architecture, such as has been shown in FIGS. 1-3 as described above.

In particular, shown is example host computer system(s) 601. For example, such computer system(s) 601 may represent those in various data centers and gNBs shown and/or described herein that host the functions, components, microservices, and other aspects described herein to implement a method for providing equivalent services to user devices across multiple participating telecommunication networks. In some embodiments, one or more special-purpose computing systems may be used to implement the functionality described herein. Accordingly, various embodiments described herein may be implemented in software, hardware, firmware, or in some combination thereof. Host computer system(s) 601 may include memory 602, one or more central processing units (CPUs) 614, I/O interfaces 618, other computer-readable media 620, and network connections 622.

Memory 602 may include one or more various types of non-volatile and/or volatile storage technologies. Examples of memory 602 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 602 may be utilized to store information, including computer-readable instructions that are utilized by CPU 614 to perform actions, including those of embodiments described herein.

Memory 602 may have stored thereon control module(s) 604. The control module(s) 604 may be configured to implement and/or perform some or all of the functions of the systems, components, and modules described herein for a method for providing equivalent services to user devices across multiple participating telecommunication networks. Memory 602 may also store other programs and data 610, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, and the like.

Network connections 622 are configured to communicate with other computing devices to facilitate the functionality described herein. In various embodiments, the network connections 622 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 618 may include a video interface, other data input or output interfaces, or the like. Other computer-readable media 620 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
accessing a global slice registry for user devices using a computing system, wherein each slice is managed by the global slice registry and each slice is used to identify and route traffic to a specific network service;
registering, in the global slice registry, slice ranges that can be accessed by other participating telecommunication networks of the multiple participating telecommunication networks, the slice ranges including a plurality of slices;
creating unified slice IDs with associated slice ranges for each corresponding user device, wherein the unified slice IDs are accessible by the multiple participating telecommunication networks;
using the unified slice IDs to enable routing to equivalent slice functionality for the network service in each of the multiple participating telecommunication networks; and
creating, using the computing system, a slice overlay network that provides user devices with an equivalent network service in each of the multiple participating telecommunication networks.

2. The method of claim 1, further comprising:
routing information between network carriers in the multiple participating telecommunication networks using slice ID routing without transmitting across a public internet.

3. The method of claim 1, wherein a managed security solution infrastructure is hosted at a host network in the multiple participating telecommunication networks, and wherein the host network enables participation by users of a remainder of the multiple participating telecommunication networks by presenting the unified slice ID that is stored in the global slice registry.

4. The method of claim 1, wherein the specific network service is one or more of a security service, a low latency service, a high availability service, a data analytics service, a threat detection service, and an autonomous vehicle telemetry service.

5. The method of claim 1, further comprising:
routing a network customer that is roaming in a roaming network using an associated slice ID of the network customer, to a slice range in a home network of the network customer, wherein the roaming network is part of the multiple participating telecommunication networks.

6. The method of claim 1, further comprising:
in response to receiving a slice ID from a network customer that is roaming, via a roaming network, sending orchestration data to the roaming network from a home network that enables the roaming network to instantiate a network slice of the home network for the network customer that is roaming.

7. The method of claim 1, wherein the global slice registry enables a regional participating telecommunication network of the multiple participating telecommunication networks to provide the same services as provided by a user device of an international participating telecommunication networks of the multiple participating telecommunication networks.

8. A system comprising:
a memory that stores computer-executable instructions; and
a processor that executes the computer-executable instructions and causes the system to:
access a global slice and Data Network Name (DNN) registry for user devices, wherein each slice/DNN is managed by the global slice and DNN registry and each slice/DNN is used to identify and route traffic to a specific network service;
register, in the global slice and DNN registry, slice/DNN ranges that can be accessed by other participating telecommunication networks of the multiple participating telecommunication networks;
create unified slice/DNN IDs with associated slice/DNN ranges for each corresponding user device, wherein the unified slice/DNN IDs are accessible by the multiple participating telecommunication networks;
use the unified slice/DNN IDs to enable routing to equivalent slice/DNN functionality for the network service in each of the multiple participating telecommunication networks; and
create a slice/DNN overlay network that provides user devices with an equivalent network service in the multiple participating telecommunication networks.

9. The system of claim 8, wherein the memory stores further computer-executable instructions that when executed, cause the system to:
route information between network carriers in the multiple participating telecommunication networks using slice ID routing without transmitting across a public internet.

10. The system of claim 8, wherein a managed security solution infrastructure is hosted at a host network in the multiple participating telecommunication networks, and wherein the host network enables participation by users of a remainder of the multiple participating telecommunication networks by presenting the unified slice/DNN ID that is stored in the global slice/DNN registry.

11. The system of claim 8, wherein the memory stores further computer-executable instructions that when executed, cause the system to:
route a network customer that is roaming in a roaming network using an associated slice/DNN ID of the network customer, to a slice/DNN range in a home network of the network customer, wherein the roaming network is part of the multiple participating telecommunication networks.

12. The system of claim 8, wherein the memory stores further computer-executable instructions that when executed, cause the system to:
in response to receiving a slice/DNN ID from a network customer that is roaming via a roaming network, send orchestration data to the roaming network from a home network that enables the roaming network to instantiate a network slice of the home network for the network customer that is roaming.

13. The system of claim 8, wherein the specific network service is one or more of a security service, a low latency service, a high availability service, a data analytics service, a threat detection service, and an autonomous vehicle telemetry service.

14. The system of claim 8, wherein the global slice/DNN slice registry enables a regional participating telecommunication network of the multiple participating telecommunication networks to provide the same services as provided by a user device of an international participating telecommunication networks of the multiple participating telecommunication networks.

15. A system comprising:
a memory that stores computer-executable instructions; and
a processor that executes the computer-executable instructions and causes the processor to:
register, in a global slice registry, slice ranges that can be accessed by participating telecommunication networks on a global slice registry for user devices, wherein slice ranges include a plurality of slices, and wherein each slice is managed by the global slice registry and each slice is used to identify and route traffic to a specific network service;
receive a connection request from a roaming customer to connect to a participating telecommunication network;
receive a destination request from the roaming customer to be routed to a specific designation using a network slice ID;
access the global slice registry and use the network slice ID to enable routing to equivalent slice functionality on the participating telecommunication network;
receive orchestration data that enables the participating telecommunication network to instantiate a roaming customer's equivalent slice functionality on the participating telecommunication network; and
instantiate the roaming customer's equivalent slice functionality on the participating telecommunication network.

16. The system of claim 15, wherein the memory stores further computer-executable instructions that when executed, cause the system to:
route information between network carriers in the multiple participating telecommunication networks using the network slice ID routing without transmitting across a public internet.

17. The system of claim 15, wherein a managed security solution infrastructure is hosted at a host network in multiple participating telecommunication networks, and wherein the host network enables participation by users of a remainder of the multiple participating telecommunication networks by presenting the network slice ID that is stored in the global slice registry.

18. The system of claim 15, wherein the memory stores further computer-executable instructions that when executed, cause the system to:
route the roaming customer to connect to the participating telecommunication network in a 4G network using Data Network Name (DNN) ID routing.

19. The system of claim 15, wherein the memory stores further computer-executable instructions that when executed, cause the system to:
route the roaming customer to connect to the participating telecommunication network in a 5G network using network slice ID routing.

20. The system of claim 15, wherein the specific network service is one or more of a security service, a low latency service, a high availability service, a data analytics service, a threat detection service, and an autonomous vehicle telemetry service.
